(19) United States
(12) Patent Application Publication
(10) Pub. No.: US 2019/0145658 A1
(43) Pub. Date: May 16, 2019

(54) IN-LINE ELECTRIC HEATER FOR PLURAL COMPONENT MATERIALS

(71) Applicant: Akurate Dynamics, LLC, Houston, TX (US)

(72) Inventors: Andrew Hodgkinson, Houston, TX (US); Trey D. Cook, Houston, TX (US)

(21) Appl. No.: 16/194,105

(22) Filed: Nov. 16, 2018

Related U.S. Application Data
(60) Provisional application No. 62/587,028, filed on Nov. 16, 2017.

(51) Int. Cl. F24H 9/02; F24H 9/14; B05B 7/22; B05B 7/16

(52) U.S. Cl. CPC F24H 9/02; B05B 7/1693; B05B 7/22; F24H 9/14

(57) ABSTRACT

An in-line electric heater for flowing fluids comprises a housing having a fluid inlet at one end and a fluid outlet at an opposing end with a plurality of resistance wire heating elements arranged along the flow path of the fluid and in direct contact with the fluid.

### CROSS-REFERENCE TO RELATED APPLICATIONS

This application claims the benefit of U.S. Application No. 62/587,028 filed on Nov. 16, 2017, the content of which is hereby incorporated by reference in its entirety.

### FEDERALLY SPONSORED RESEARCH OR DEVELOPMENT

Not Applicable

### BACKGROUND OF THE INVENTION

### 1. Field of the Invention

The present invention generally relates to electric resistance heaters. More particularly, it relates to electric resistance heaters for heating flowing liquids used in plural component materials such as spray foam insulation formed by the reaction of an isocyanate with a polyol resin.

### 2. Description of the Related Art Including Information Disclosed Under 37 CFR 1.97 and 1.98

U.S. Pat. No. 4,501,952 to Lehrke describes a fluid heater, particularly for heating paints, lacquers, varnishes and other spray coating material that includes an elongated hollow tube adapted to be inserted into a fluid flow line for fluid flow through the tube. An electric resistance heater is disposed within the tube and is surrounded by a helical coil member to create a helical fluid flow path through the tube. A temperature control system for regulating the operation of the heater includes a temperature sensing probe comprising a temperature responsive resistance element enclosed in a conical housing extending into the helical fluid flow path and having its apex contacting the heater and its conical surface area increasing in a direction away from the heater and extending across the cross section of the fluid flow path. The temperature control system is responsive to both the temperature and the rate of change of temperature of the probe and includes an ambient temperature compensation circuit for monitoring the ambient temperature and compensating temperature control circuits for regulating heater temperature as a function of ambient temperature as well as a function of static and dynamic fluid flow conditions in the helical flow path sensed by the probe.

U.S. Pat. No. 9,156,046 to Jerdee et al. describes a liquid in a conduit heater assembly that includes a plurality of heater modules each having a plurality of bores forming at least a first component path and a second component path, and at least one heating element receptacle configured to receive a heating element for heating the first and second component paths.

U.S. Pat. No. 9,221,669 to Tix et al. describes a fluid pumping system that comprises an internal combustion engine, a generator, a pumping unit and a heat recovery system. The generator is driven by the internal combustion engine. The pumping unit is powered by the generator. The heat recovery system thermally couples the internal combustion engine with the pumping unit.

U.S. Publication No. 2017/0122475 by Jerdee et al. describes a modular fluid delivery assembly that comprises a fluid conduit. The modular fluid delivery assembly also comprises an electrical heating element disposed within the fluid conduit. The electrical heating element is configured to provide a heat source within the fluid conduit. The modular fluid delivery assembly also comprises a connection assembly, located proximate an end of the modular fluid delivery assembly, coupled to the heating element and the fluid conduit. The connection assembly is configured to provide a hydraulic coupling to the fluid conduit, and to provide an electronic coupling to the electrical heating element.

Resistance wire is wire intended for making electrical resistors (which are used to control the amount of current in a circuit). It is better if the alloy used has a high resistivity, since a shorter wire can then be used. In many situations, the stability of the resistor is of primary importance, and thus the alloy's temperature coefficient of resistivity and corrosion resistance play a large part in material selection.

When resistance wire is used for heating elements (in electric heaters, toasters, and the like), high resistivity and oxidation resistance is important.

Nichrome, a non-magnetic 80/20 alloy of nickel and chromium, is the most common resistance wire for heating purposes because it has a high resistivity and resistance to oxidation at high temperatures. When used as a heating element, resistance wire is usually wound into coils. One difficulty in using nichrome wire is that common tin-based electrical solder will not bond with it, so the connections to the electrical power must be made using other methods such as crimp connectors or screw terminals.

Kanthal (Alloy 875/815), a family of iron-chromium-aluminum (FeCrAl) alloys used in a wide range of high-temperature applications.

Constantan [Cu55Ni45] has a low temperature coefficient of resistivity and as a copper alloy, is easily soldered. Other constant-resistance alloys include Manganin [Cu86Mn12Ni2], Cupron [Cu53Ni44Mn3] and Evanohm.

Nichrome (NiCr, nickel-chrome, chrome-nickel, etc.) is any of various alloys of nickel, chromium, and often iron (and possibly other elements). The most common usage is as resistance wire.

The Evanohm® family of nickel-chrome alloys—e.g. Alloy 2 [Ni72Cr20Mn4Al3Si1] and Alloy R [Ni73.5Cr20Cu2Al2.5Mn1Si1] (Carpenter Technology Corp., 1735 Market St., Philadelphia, Pa. 19103)—have high resistance, low temperature coefficient of resistance, low electromotive force (Galvanic potential) when in contact with copper, high tensile strength, and also are very stable with regards to heat treatment.

Many elements and alloys have been used as resistance wire for special purposes.

Patented in 1906 by Albert Marsh (U.S. Pat. No. 811,859), nichrome is the oldest documented form of resistance heating alloy. A common nichrome alloy is 80% nickel and 20% chromium, by mass, but there are many other combinations of metals for various applications. Nichrome is consistently silvery-grey in color, is corrosion-resistant, and has a high melting point of about 1400° C. (2550° F.). Because of its low cost of manufacture, strength, ductility, resistance to oxidation, stability at high temperatures, and resistance to the flow of electrons, nichrome is widely used in electric heating elements in applications such as hair dryers and heat guns. Typically, nichrome is wound in coils to a certain electrical resistance, and when current is passed through it the Joule heating produces heat.

Almost any conductive wire can be used for heating, but most metals conduct electricity with great efficiency, requiring them to be formed into very thin and delicate wires in order to create enough resistance to generate heat. When heated in air, most metals then oxidize quickly, become brittle, and break. Nichrome wire, however, when heated to red-hot temperatures, develops an outer layer of chromium oxide, which is thermodynamically stable in air, is mostly impervious to oxygen, and protects the heating element from further oxidation.

Circulation heaters or “direct electric heat exchangers” (DEHE) use heating elements inserted into a “shell side” medium directly to provide the heating effect. All the electric heat generated by the electric circulation heater is transferred into the medium, thus an electric heater is 100 percent efficient. Direct electric heat exchangers or “circulation heaters” are used to heat liquids and gases in industrial processes.

### SUMMARY OF THE INVENTION

An in-line electric heater for flowing fluids comprises a housing having a fluid inlet at one end and a fluid outlet at an opposing end with a plurality of electric resistance heating elements arranged along the flow path of the fluid and in direct contact with the fluid.

### BRIEF DESCRIPTION OF THE SEVERAL VIEWS OF THE DRAWING(S)

FIG. 1A is an exploded view of an exemplary embodiment of the invention.

FIG. 1B is a cross-sectional view of an alternative heater power feedthrough.

FIG. 2A is a perspective view of the heater element frame of the embodiment illustrated in FIG. 1A.

FIG. 2B is a side view of the heater element frame of the embodiment illustrated in FIG. 1A.

FIG. 3 is an end view of the heater element frame of the embodiment illustrated in FIG. 1A.

FIG. 4 is an end view of the bottom cap of the in-line fluid heater illustrated in FIG. 1A.

FIG. 5 is a perspective view of the heater element frame of the embodiment illustrated in FIG. 1A without heater wires installed.

### DETAILED DESCRIPTION OF THE INVENTION

The invention may best be understood by reference to the exemplary embodiments shown in the drawing figures.

The following elements are illustrated in the drawing figures:
10 in-line fluid heater
12 fluid entry port
14 wire loom assembly
18 resistance heating wire
20 pressure housing
22 fluid exit port
24 temperature sensor
25 through hole for temperature sensor
26 compression cap
28 compression bung
30 top cap
32 spacer
34 bottom cap
36 wire loom end plate
38 seal
40 recess
42 blind holes
44 fluid flow holes
45 teardrop-shaped fluid flow holes
46 heater wire holes
48 temperature sensor lead
50 power feed bore
60 pressure-sealed connection
75 third passageway
76 sensor adapter block
77 first passageway
78 second passageway
79 cap
80 heating element
81 uninsulated portion
82 heater power input
84 heater power return
100 power feedthrough
102 (metal) body
104 shell portion
106 insulator
108 conductor
110 O-ring seal
112 heating element connector
113 through hole
114 power connector
115 bleed hole
116 threaded retainer cap
118 bore
120 groove
122 stop insert
123 shoulder
124 shoulder
126 filler

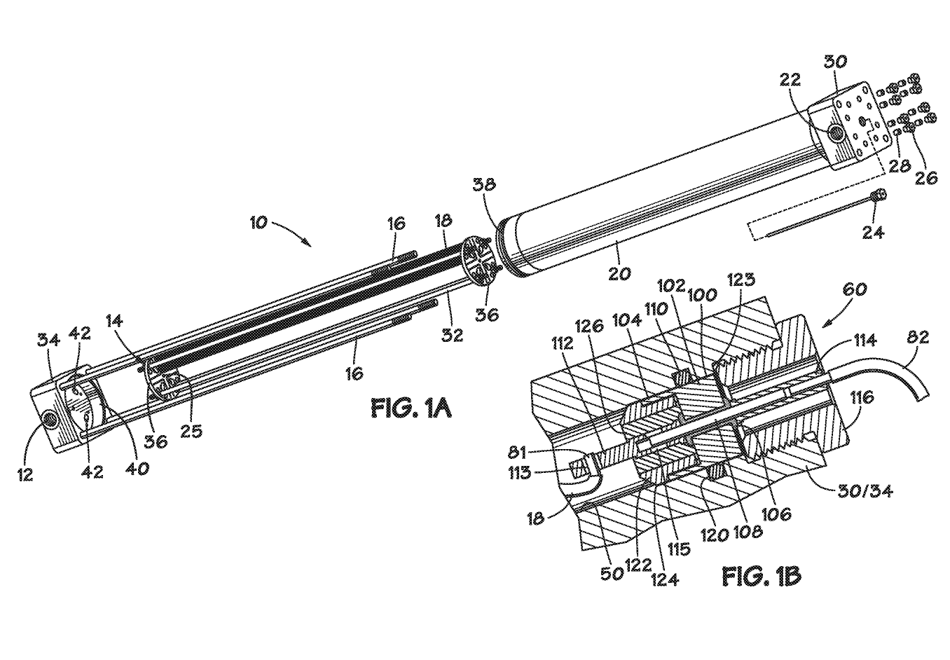

Referring first to the exploded view of FIG. 1, exemplary electric in-line fluid heater 10 comprises generally cylindrical pressure housing 20 in sealing engagement with top cap 30 at a first end thereof and bottom cap 34 at an opposing second end thereof. Bottom cap 34 has fluid entry port 12 therein and top cap 30 has fluid exit port 22 therein. Pressure housing 20 may have seal 38 for sealing with recess 40 in bottom cap 34. In an embodiment, seal 38 is an O-ring seal in a circumferential groove proximate the second end of pressure housing 20. The first end of pressure housing 20 may be equipped with a similar seal (not shown).

Bottom cap 34 may be attached to top cap 30 by tie rods 16 which may be threaded rods secured with nuts. Tie rods 16 hold bottom cap 34 and top cap 30 in sealing engagement with pressure housing 20. In an embodiment, top cap 30 and bottom cap 34 are aluminum and pressure housing 20 and tie rods 16 are stainless steel.

Resistance heating wires 18 are supported on loom assembly 14 which comprises opposing wire loom end plates 36 held in spaced-apart relation by spacer rods 32. In an embodiment, resistance heating wires 18 are INCONEL® wires [HUNTINGTON ALLOYS CORPORATION, 3200 RIVERSIDE DRIVE, HUNTINGTON, WEST VIRGINIA 25720] coated with TEFLON® polytetrafluoroethylene [THE CHEMOURS COMPANY FC, LLC, 1209 ORANGE STREET, WILMINGTON DELAWARE 19801]. Resistance heating wires 18 and their associated power return lines (the neutral line in an AC-powered system) may exit top cap 30 via compression caps 26 which engage and compress compression bungs 28 to provide a fluid-tight seal around wires 18.

Blind holes 42 may be provided in recess 40 of end caps 30 and 34 for receiving the ends of spacer rods 32 that project through wire loom end plates 36. In this way, wire loom assembly 14 may be held centered within and in spaced-apart relation to pressure housing 20.

Temperature sensor 24 may be provided in top cap 30 for sensing the temperature of a fluid being heated within pressure housing 20 by resistance heating wires 18. Temperature sensor 24 may be a thermocouple, a thermistor or any other suitable sensor for providing a temperature-dependent signal to a power controller for resistance heating wires 18. A temperature sensor may alternatively or additionally be provided in bottom cap 34 or pressure housing 20. Temperature sensor 24 may be in a thermowell. One or more through holes 25 may be provided for a probe section of temperature sensor 24 in one or both of wire loom end plates 36.

In-line fluid heater 10 may be mounted in any orientation. In an embodiment, heater 10 is mounted vertically with the fluid inlet in top cap 30. In other vertically oriented mountings, the fluid inlet may be in bottom cap 34.

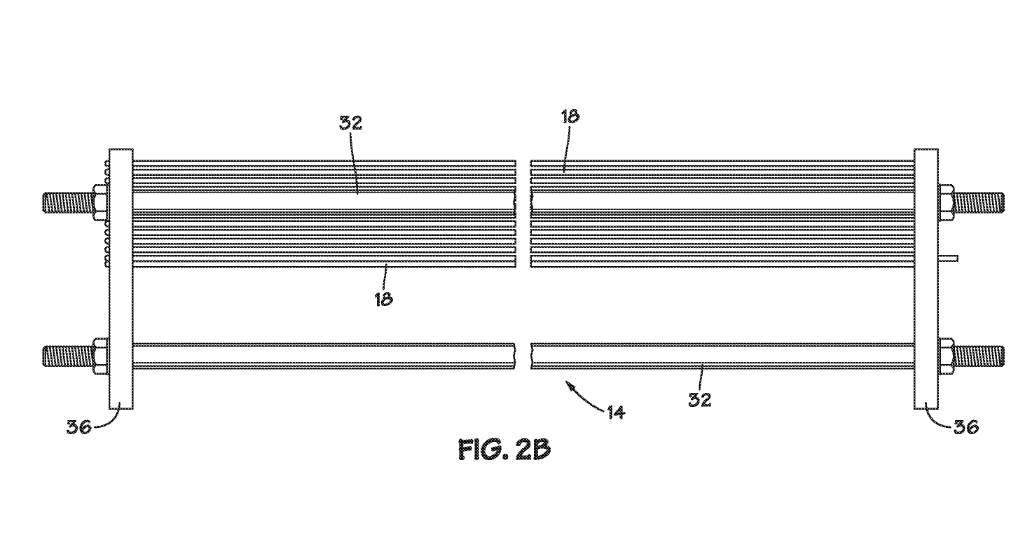

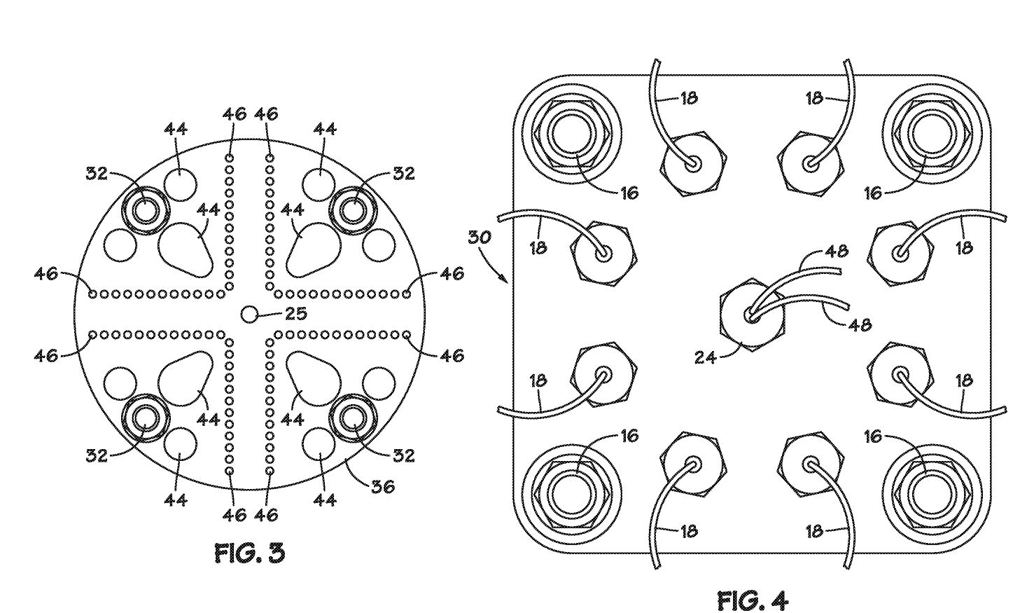

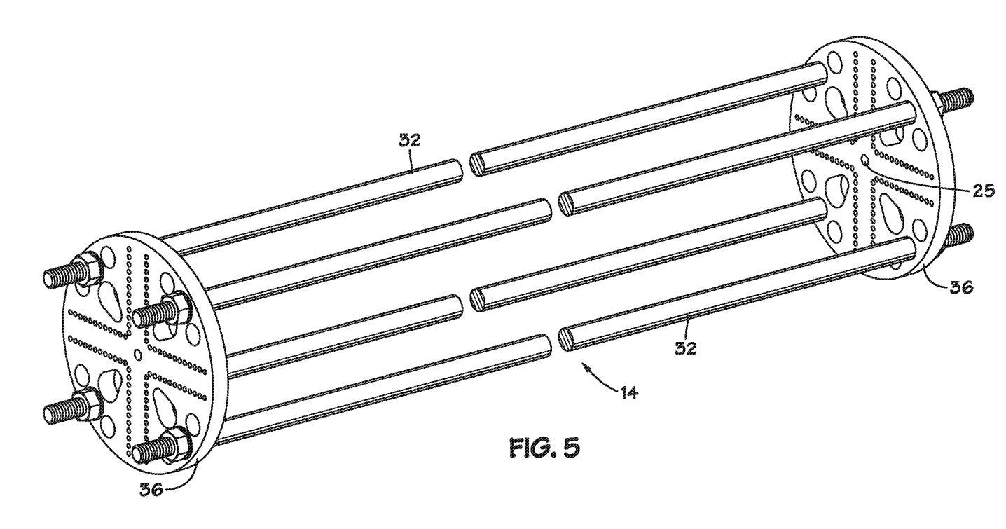

As may be best seen in FIG. 3, wire loom end plate 36 may be provided with larger fluid flow holes 44, 45 and smaller heater wire holes 46. In certain embodiments, teardrop-shaped fluid flow holes 45 may be sized and configured to induce turbulence in a fluid flowing through fluid heater 10. Inducing turbulence in a fluid flowing through fluid heater 10 may improve its heating effectiveness by bringing a greater portion of the fluid volume into direct contact with resistance heating wires 18. In an embodiment, wire loom end plates 36 are fabricated of polyetheretherketone (PEEK). Other chemically inert and electrically insulating engineering plastics (e.g. DELRIN; TEFLON; and the like) may also be used to fabricate wire loom end plates 36. If heater wires 18 are electrically insulated, wire loom end plates may be made of a conductive material—e.g. stainless steel. In an embodiment, spacers 32 are threaded, stainless steel rods.

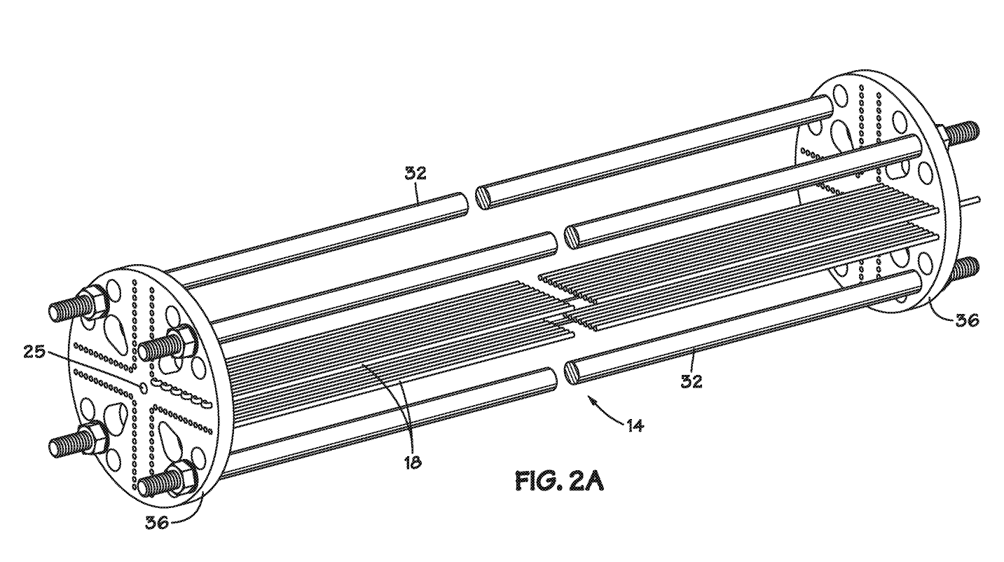

Heater wire holes 46 may be arranged in multiple arrays in end plates 36. In each of the four L-shaped arrays in the embodiment illustrated in FIG. 2A, the heater wires are laced through opposing holes 46 in opposing end plates 36 to produce eight arrays each having 12 resistance heating wire runs parallel to one another in a substantially planar arrangement. Having a plurality of heater wires 18 running substantially the full length of pressure housing 20 (96 heater wire runs in the embodiment illustrated in FIGS. 2A and 2B) increases the surface area of the heating elements thereby improving heat transfer from the heating elements to the fluid flowing through the in-line heater.

In certain embodiments, each array of resistance heating wires 18 may be on a separate circuit and may be separately controlled. The heating level may be controlled by switching on one or more of the heating circuits. If each of four heating circuits has the same wattage, four levels of heating may be obtained in this way. If each of four heating circuits has a unique wattage, 16 levels of heating may be obtained by selectively switching the heating circuits. In an embodiment having four heating circuits of equal wattage, the nominal power of the heater may be provided by operating only two of the heater circuits. In this way, two backup heater circuits are available in the event one or both the primary heater circuits fail. In embodiments having multiple heating circuits, the heating circuits may be wired in series or in parallel.

In an embodiment, resistance heating wires 18 may provide 1750 watts of heating power to a fluid flowing through housing 20. Resistance heating wires 18 may be in electrical communication with a power controller (not shown) that is responsive to temperature sensor 24 via temperature sensor leads 48.

In certain embodiments, fluid heater 10 is wrapped or otherwise encased in a thermally insulating material (not shown). In an embodiment, the insulating material comprises foil insulation.

Commonly owned U.S. patent application Ser. No. 16/127,308 filed on Sep. 11, 2018, describes an improved power feedthrough for a heated hose. The heated hose has a pressure housing at or near both its inlet and its outlet. The heater is an electric resistance heater located within the flow channel of the hose. A power feedthrough in one pressure housing provides a fluid-tight electrical power connection to the electric resistance heater in the flow channel. A power feedthrough in the other pressure housing provides a fluid-tight power return connection to the electric resistance heater in the flow channel.

The power feedthrough comprises a generally cylindrical body having a central axial bore. A conductor pin is situated within the central axial bore in spaced apart relation thereto creating an annulus. The annulus is filled with an insulating material such as a ceramic.

The power feedthroughs are retained within bores in each of the pressure housings. The bores have a circumferential groove in their inner walls which hold a seal such as an O-ring seal in sealing engagement with the outer surface of the generally cylindrical body of the power feedthrough.

A similar power feedthrough may be used in the present invention for resistance heating wires 18 in place of compression bung 28 and compression cap 26. The content of U.S. patent application Ser. No. 16/127,308 is hereby incorporated by reference in its entirety.

In an alternative embodiment, electrical power lead 82 for resistance heating wires 18 enters and exits apparatus 10 via pressure-sealed connections 60 within end caps 30 and/or 34.

Referring now to FIG. 1B, the details of pressure-sealed connection 60 for heater power input 82 are described below. It should be understood that the elements and configuration of pressure-sealed connection 60 for a heater power return may be identical to those of heater power input 82, as is illustrated in FIG. 1B.

End caps 30 and/or 34 are provided with a bore 50 that is internally threaded at a first end thereof which is open to an external surface of end cap 30 or 34. An opposing second end of bore 50 is open to the interior of pressure housing 20. A circumferential groove 120 is provided in the wall of bore 50 for O-ring seal 110. Bore 50 may have a first portion with a first internal diameter (i.d.) adjacent the opening of bore 50 to the exterior of end caps 30 and/or 34 and a second portion with a second i.d. smaller than the first i.d. with a first shoulder x23 between the first portion and the second portion. Bore 50 may have a third portion adjacent the second portion that has a third i.d. that is less than the second i.d. thereby forming a second shoulder 124. As shown in FIG. 1B, shoulder 124 may be beveled.

Power feedthrough 100 is sized to fit within the second portion of bore 50 in sealing engagement with circumferential O-ring seal 110. Other seal types may be used. Power feedthrough 100 comprises cylindrical body 102 which, in certain embodiments, is formed of stainless steel. Cylindrical body 102 has a central axial bore having a first portion proximate the end of body 102 that is adjacent threaded retainer cap 116 in FIG. 1B, said first portion having a first smaller inside diameter (i.d.) and a second portion proximate the end of body 102 that is adjacent stop insert 122 in FIG. 1B, said second portion having a second larger i.d. that is greater than the first smaller i.d. thereby forming shell portion 104 of body 102.

Conductor pin 108 is held within the central axial bore of body 102 by insulator 106. In an embodiment, insulator 106 is a ceramic material. As illustrated in FIG. 1B, insulator 106 may fill the annular space between conductor pin 108 and the wall of the central axial bore in body 102 in the first portion of the bore and overlap a portion of body 102 around the central axial bore on both the exterior portion of body 102 and the internal shoulder of body 102 between the first portion and the second portion of the central axial bore. Conductor pin 108 may be formed of any suitable electrical conductor and may extend for a distance beyond the right end (in FIG. 1B) of body 102 and for a distance into shell portion 104 sufficient to permit the connection of electrical leads. In yet other embodiments (not shown), body 102 may be formed of an insulating material and insulator 106 is not required.

Power feedthrough 100 may be retained in bore 50 between threaded retainer cap 116 and stop insert 122. In an embodiment, stop insert 122 is formed of an engineering plastic such as, for example, polytetrafluoroethylene (PTFE), polyetheretherketone (PEEK), nylon, or the like. As illustrated in FIG. 1B, stop insert 122 may fit partially into shell portion 104 of body 102 of power feedthrough 100. Stop insert 122 may have an interference fit with the inner surface of shell portion 104 of body 102 of power feedthrough 100 such that stop insert 122 and power feedthrough 100 may be inserted as an assembly into bore 50 with heating wire 18 connected to conductor pin 108 by means of heating element connector 112. Heating element connector 112 may be provided with bleed hole 115 to facilitate connection to conductor pin 108 and with through hole 113 for connection to uninsulated portion 81 of heating wire 18 by, for example, soldering. The annulus between heating element connector 112 and the interior surface of stop insert 122 may be filled with a filler 126. In an embodiment, filler 126 is an epoxy resin.

Stop insert 122 may be sized and configured to contact shoulder 124 within bore 50 and thereby limit its travel in bore 50 towards internal fluid conduit 44. It will be appreciated that shoulder 124 may be quite narrow (the difference in i.d. of bore 50 creating a shoulder being about 0.001 inch in an embodiment) inasmuch as fluid pressure within pressure housing 20 and the connecting portion of bore 50 tends to urge the assembly of stop insert 122 and power feedthrough 100 off of shoulder 124. In certain embodiments (particularly those wherein body 102 is formed of an insulating material), power feedthrough 100 and stop insert 122 may be combined as a single piece.

Threaded retainer cap 116 has central axial bore 118 into which a portion of conductor pin 108 projects as well as an end of heater power input 82 (or a heater power return). In certain embodiments, threaded retainer cap 116 may be sized and configured to contact shoulder 123 within bore 50. In other embodiments, as illustrated in FIG. 1B, there may be a gap between the interior end of cap 116 and shoulder 123. It will be appreciated that cap 116 mechanically retains power feedthrough 100 in bore 50 while O-ring 110 provides the fluid-tight seal between the body of end caps 30 and/or 34 and power feedthrough 100. As such, the assembly of body 102 and stop insert 122 may slide within bore 50 while maintaining a fluid-tight seal so long as O-ring 110 is able to maintain sealing engagement with the exterior surface of body 102 of power feedthrough 100.

Power connector 114 may be used to connect the exterior end of conductor pin 108 to heater power input 82 (or a heater power return), as the case may be). In an embodiment, power connector 114 is a crimp connector. An insulator (not shown) may be provided around the exterior of power connector 114. In an embodiment, such insulator comprises heat-shrink tubing.

A power supply (not shown) and/or power controller may be connected to the ends of electric resistance heating wires 18. The power supply may be an AC or DC power supply. The circuit is completed to generate heat from electric resistance heating wires 18 within pressure housing 20. A power return line may be provided which may be the neutral line in an AC-powered system. In an embodiment, the return power line comprises an insulated, low-resistance conductor such as copper.

The foregoing presents particular embodiments of a system embodying the principles of the invention. Those skilled in the art will be able to devise alternatives and variations which, even if not explicitly disclosed herein, embody those principles and are thus within the scope of the invention. Although particular embodiments of the present invention have been shown and described, they are not intended to limit what this patent covers. One skilled in the art will understand that various changes and modifications may be made without departing from the scope of the present invention as literally and equivalently covered by the following claims.

What is claimed is:

1. An in-line electric heater for flowing fluids comprising:
a generally cylindrical housing having a first end and an opposing second end;
an inlet end cap attached to the first end of the housing;
an outlet end cap attached to the second end of the housing;
a heater element frame disposed within the housing and having a first end and an opposing second end;
at least one insulated, resistance wire heating element supported on the heater element frame in a substantially linear array of loops extending from the first end of the heater element frame to the second end of the heater element frame, said resistance wire heating element configured to be in direct contact with a fluid flowing through the generally cylindrical housing; and
a first temperature sensor in contact with the fluid flowing through the generally cylindrical housing.

2. The in-line electric heater recited in claim 1 wherein the first temperature sensor is mounted in one of the inlet end cap and the outlet end cap.

3. The in-line electric heater recited in claim 2 further comprising:
a second temperature sensor mounted in the other end cap and in contact with the fluid flowing through the generally cylindrical housing.

4. The in-line electric heater recited in claim 1 further comprising:
standoffs on the heater element frame to hold the heater element frame in spaced-apart relation to the inlet end cap and the outlet end cap.

5. The in-line electric heater recited in claim 4 wherein the standoffs are configured to engage at least one of the inlet end cap and the outlet end cap to prevent rotation of the heater element frame within the generally cylindrical housing.

6. The in-line electric heater recited in claim 1 further comprising a plurality of resistance wire heating elements each of which being separately switched.

7. The in-line electric heater recited in claim 6 wherein one or more of the plurality of resistance wire heating elements has a different wattage than at least one other of the electric resistance heating elements.

8. The in-line electric heater recited in claim 6 wherein each of the plurality of resistance wire heating elements has a different wattage than any other of the electric resistance heating elements.

9. The in-line electric heater recited in claim 1 wherein at least one insulated, resistance wire heating element is generally parallel to a longitudinal axis of the generally cylindrical housing.

10. The in-line electric heater recited in claim 1 wherein the at least one insulated, resistance wire heating element comprises nichrome wire.

11. The in-line electric heater recited in claim 1 wherein the at least one insulated, resistance wire heating element comprises an austenitic nickel-chromium-based alloy.

12. The in-line electric heater recited in claim 10 wherein the nichrome wire is coated with polytetrafluoroethylene.

13. The in-line electric heater recited in claim 1 wherein the heater element frame comprises an opposing pair of wire loom plates held in spaced-apart relation.

14. The in-line electric heater recited in claim 13 wherein the wire loom end plates comprise a plurality of through holes sized and spaced to hold the at least one insulated, resistance wire heating element.

15. The in-line electric heater recited in claim 14 wherein the at least one resistance wire heating element is laced through the plurality of through holes.

16. The in-line electric heater recited in claim 14 wherein the wire loom end plates additionally comprise at least one through hole sized and spaced to permit passage of the temperature sensor therethrough.

17. The in-line electric heater recited in claim 14 additionally comprising:
at least one through hole in each of the wire loom end plates sized and configured to allow passage of a fluid to be heated.

18. The in-line electric heater recited in claim 17 the at least one through hole sized and configured to allow passage of a fluid to be heated is configured to induce turbulence in a fluid passing through the hole.

19. The in-line electric heater recited in claim 18 wherein at least one through hole has a teardrop shape.

20. The in-line electric heater recited in claim 1 further comprising:
a power feedthrough in a bore in at least one of the top end cap and the bottom end cap, in electrical connection with the resistance wire heating element and comprising
a generally cylindrical body having a central axial bore;
a conductor pin within the central axial bore connected at a first end thereof to the resistance wire heating element; and
a seal in a wall of the bore in at least one of the top end cap and the bottom end cap, in sealing engagement with an external surface of the generally cylindrical body of the first power feedthrough.

21. The in-line fluid heater recited in claim 20 wherein the seal in a wall of the bore in at least one of the top end cap and the bottom end cap is in a circumferential groove in the wall of the bore.

22. The in-line fluid heater recited in claim 21 wherein the seal is an O-ring seal.

23. The in-line fluid heater recited in claim 20 wherein the conductor pin is in spaced-apart relation to an inner surface of the central axial bore of the power feedthrough thereby forming an annulus.

24. The in-line fluid heater recited in claim 23 wherein the annulus is filled with an electrical insulator.

25. The in-line fluid heater recited in claim 24 wherein the electrical insulator comprises a ceramic material.

26. The in-line fluid heater recited in claim 20 wherein the central axial bore of the first power feedthrough has a first portion having a first inside diameter (i.d.) and a second portion adjacent the first portion and having a second i.d. that is greater than the first i.d.

27. The in-line fluid heater recited in claim 26 wherein the conductor pin extends into the second portion of the central axial bore.

28. The in-line fluid heater recited in claim 27 further comprising a heating element connector in electrical contact with the resistance wire heating element at a first end thereof and in electrical contact with the conductor pin at a second opposing end thereof.

29. The in-line fluid heater recited in claim 28 further comprising a generally tubular stop insert at least partially within the second portion of the central axial bore of the first power feedthrough.

30. The in-line fluid heater recited in claim 29 wherein the tubular stop insert is sized to create an annulus between an inner wall of the tubular stop insert and the heating element connector and the annulus is filled with an epoxy filler.

31. The in-line fluid heater recited in claim 29 wherein the bore in at least one of the top end cap and the bottom end cap has a first section having a first inside diameter (i.d.), a second section having a second i.d. that is less than the first i.d. thereby forming a first shoulder between the first section and the second section, and a third section having a third i.d. that is less than the second i.d. thereby forming a second shoulder between the second section and the third section and the stop insert is sized and configured to rest on the second shoulder.

32. The in-line fluid heater recited in claim 31 wherein the first section of the bore in at least one of the top end cap and the bottom end cap is internally threaded and the assembly further comprises a retainer cap in threaded engagement with the first section of the intersecting bore said retainer cap sized and configured to retain the first power feedthrough in the second section of the bore in at least one of the top end cap and the bottom end cap.
